(19) United States
(12) Patent Application Publication
(10) Pub. No.: US 2010/0040150 A1
(43) Pub. Date: Feb. 18, 2010

(54) METHOD AND APPARATUS FOR ENCODING VIDEO DATA STREAM

(75) Inventor: Jin Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,187

(22) PCT Filed: Dec. 15, 2005
(86) PCT No.: PCT/IB2005/054257

§ 371 Date: Oct. 29, 2009

(30) Foreign Application Priority Data
Dec. 29, 2004 (CN) 200410103627.6

(51) Int. Cl. H04N 7/32

(52) U.S. Cl. 375/240.24; 375/E07.2

(57) ABSTRACT

The invention discloses a method and apparatus for encoding video data stream. In accordance with the method provided by the invention, firstly, compares the difference between each data block of the unit to be encoded and a reference data block having the corresponding address in a reference unit; and, determines whether the difference corresponding to each data block complies with a preset reference value. If it is less than the preset reference value, then the macro-block is indicated for obtaining the video data of the macro-block by decoding on the basis of data of reference data macro-block. Otherwise the macro-block is encoded. With the invention, it can be determined whether the macro-block should be encoded without motion prediction, motion compensation and/or DCT, etc., which greatly simplifies the procedure of determining whether the macro-block should be encoded and saves the system resources.

### FIELD OF THE INVENTION

The present invention relates to data coding, more specifically to a method and an apparatus for coding video data stream.

### BACKGROUND OF THE INVENTION

The digital video technique has been widely applied to the field of communication, computer, broadcasting television and so on. For example, video encoding is generally used in video conference, video phone, digital television and media storage. There are various standard for video encoding in the field of video processing. ITU-T and ISO/IEC are the two organizations to establish the standards for video encoding. The standards set up by ITU-T include H.261, H.263, H.264, etc., which are mainly applied to instant video communication, such as video conference; ISO/IEC also sets up a series of standards for moving picture experts group, which are mainly applied to video media storage, broadcasting television and the stream media in Internet and radio networks.

It is well known that video signals have much redundant information in time and space. Spatial redundant information reflects the strong correlation between neighboring pixels in a frame image. While temporal redundant information reflects strong correlation of the image with respect to the forward and backward neighboring images (for example, a motion sequence). Redundant information results in a large amount of video data. Therefore, in order to reduce the amount of video data, various processing methods are used to reduce the redundant information of video data.

In general, a discrete cosine transform (DCT) can be employed in the direction of space to, reduce the redundant information of video signal. And the algorithm of motion prediction and motion compensation can be employed in the direction of time to reduce the redundant information of video signal. The motion vector obtained from motion prediction presents the motion information of macro-block. The prediction difference from motion compensation presents the difference between the current frame and the reference frame of a video signal.

When encoding a current frame, a macro-block generally acts as a basic encoding unit. A macro-block is defined as a block of I×J pixels, wherein I×J can be 16×16, 8×8 or 4×4, etc. In general, among the coding criterions, a macro-block that best matching the current macro-block is required to be found as the reference macro-block when encoding the data. The so-called best matching means that the difference between the two macro-blocks is minimum. Normally, the absolute difference minimum or the mean-square error minimum is used as the matching decision.

Combined with the reference macro-block, the value of a prediction error and a motion vector can present one current macro-block. If the motion vector of the current macro-block is zero with respect to the reference macro-block and the prediction error obtained from DCT is also zero after quantification, it is not necessary to encode the current macro-block (which is normally called Skip) but indicate the address information of this macro-block. The data of this macro-block can be recovered with the reference macro-block during the procedure of decoding.

In order to determine whether a macro-block should be encoded, it is required to process a large amount of data, such as motion prediction, motion compensation, DCT and quantification, which is complex and consume massive computing resources.

Consequently, it is desired to provide a method and an apparatus for encoding video data stream, which can determine quickly whether the macro-blocks in video data stream should be encoded and make the process simpler.

### OBJECT AND SUMMARY OF THE INVENTION

The object of the present invention is to provide a method and an apparatus for encoding a video data stream to overcome the defects in the prior art so as to reduce the computing resource.

In accordance with an embodiment of the present invention, a method for encoding a video data stream is proposed, the video data stream comprising at least one unit to be encoded, the unit to be encoded comprising at least one data block, the method comprising:

comparing the difference between each data block of the unit to be encoded and a reference data block having the corresponding address in a reference unit; and

determining whether the difference corresponding to each data block complies with a preset condition, so as to determine whether the unit to be encoded should be encoded.

In the above method, the unit to be encoded comprising a data macro-block, the reference unit being a reference data macro-block. The difference comprises a power difference, the preset condition comprising a preset reference value.

In the above method, wherein if the value of power difference corresponding to each data block is less than the preset reference value, then the macro-block is indicated so as to obtain the video data of the macro-block by decoding on the basis of video data of the reference data macro-block. If the value of power difference corresponding to a data block of the each data block is larger than the preset reference value, then the data macro-block is encoded.

In accordance with an embodiment of the present invention, an apparatus for encoding video data stream is proposed, wherein the video data stream comprising at least one unit to be encoded, the unit to be encoded comprising at least one data block, the apparatus comprising:

a comparing means for comparing the difference between each data block of the unit to be encoded and a reference data block having the corresponding address in a reference unit; and

a determining means for determining whether the difference corresponding to each data block complies with a preset condition, so as to determine whether the unit to be encoded should be encoded.

In the above apparatus, the unit to be encoded comprising a data macro-block, the difference comprising a value of power difference, the preset condition comprising a preset reference value.

In the apparatus above, further comprising:

an indicate means for indicating the macro-block in which the value of power difference corresponding to each data block is less than the preset reference value so as to obtain the video data of the macro-block by decoding on the basis of video data of the reference data macro-block.

The apparatus further comprising: a processing means for encoding the macro-block in which the value of power difference corresponding to one data block is larger than the preset reference value.

In accordance with the present invention, with the following steps, whether the macro-block need be encoded can be determined. That is, comparing the power difference between each data block of a macro-block and a reference data block having the corresponding address in a reference block; comparing each of the power differences with a preset reference value. With the above method, a motion prediction, a motion compensation or other processes are not needed. This greatly simplifies the procedure to determine whether the macro-block should be encoded, and greatly reduce the system resource.

Other object and advantage of the present invention will become apparent and comprehensible through the following description in combination with the accompanying drawings and the contents of the claims

### BRIEF DESCRIPTION OF DRAWINGS

In the following, the preferred embodiments of the invention will be described with reference to the drawings, wherein:

FIG. 1 is a flowchart of a method for encoding a video data stream according to an embodiment of the invention.

FIG. 2 is a block diagram of the apparatus for encoding a video data stream according to an embodiment of the invention.

Among the above figures, a same reference numeral represents a same or similar component.

### DETAILED DESCRIPTION OF THE INVENTION

The spirit of this invention is as follows. If the difference between the power of each data block in a macro-block and that of the data block having corresponding address in the reference macro-block is less than a reference value, the macro-block can be recovered by decoding on the basis of the reference macro-block without encoding. Otherwise encoding is required. In this way, it can judge whether the macro-block is required to be encoded without a motion prediction, motion compensation, etc. Therefore, the procedure for determining whether the macro-block should be encoded is significantly simplified, which saves the system resources.

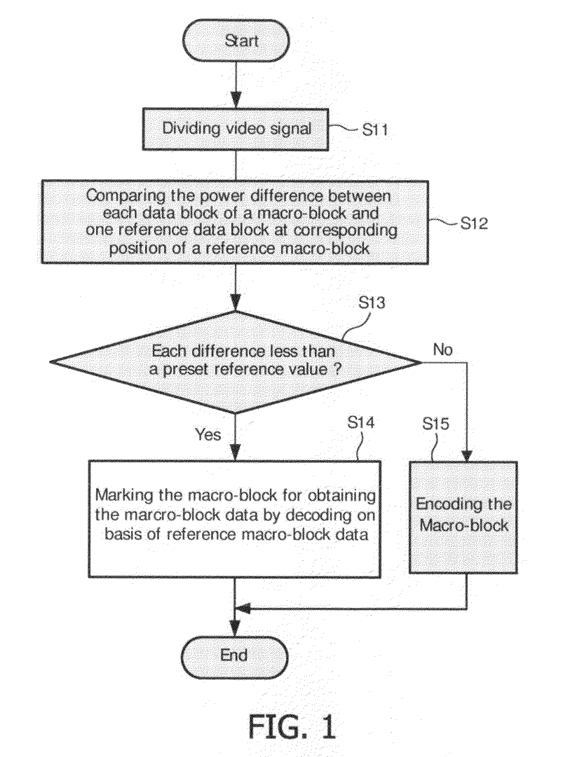

FIG. 1 is a flowchart of a method for encoding a video data stream according to an embodiment of the invention. Firstly, at step S11, the current frame of the video signal is divided into multiple macro-blocks with 16×16 pixels, each macro-block including four luminance blocks with 8×8 pixels.

The person skilled in the art should understand that the present application should not be limited to this. The invention also applies to the situation that the current frame is divided into multiple macro-blocks with 8×8 pixels or 4×4 pixels, etc., each macro-block including multiple luminance blocks with I×J pixels. Further, since a video data includes a luminance component, a color level component, etc., the macro-block also includes multiple color level blocks, etc.

For the purpose of simplification, the following description will be based on the fact that the current frame of the video signal is divided into multiple macro-blocks with 16×16 pixels, each macro-block including four luminance blocks with 8×8 pixels.

Then at step S12, the power error between each luminance block in the reference macro-block and that with corresponding address in the current macro-block is compared. That is, the power error eₖ between the luminance blocks having zero motion vectors at the same position.

The formula for the above power error is as follows:

$${e}_{k} = {\sum }_{x = 0}^{7} {\sum }_{y = 0}^{7} {( {f}_{c , k} ( x , y ) - {f}_{p , k} ( x , y ) )}^{2} ( k = 1 , 2 , 3 , 4 ) \qquad ( 1 )$$

where f_{c,k}(x, y) represents the sample value of luminance of k-th luminance block in one macro-block of the current frame, f_{p,k}(x, y) presents the sample value of luminance of k-th luminance block at the same position in the reference frame.

Then, at step S13, whether the current macro-block in the current frame should be encoded is determined based on the result obtained from comparison result in step S12.

Since DCT is a kind of unit transform, which has a character of keeping power, that is:

$$E = {\sum }_{x = 0}^{7} {\sum }_{y = 0}^{7} {( f ( x , y ) )}^{2} = {\sum }_{u = 0}^{7} {\sum }_{v = 0}^{7} {( F ( u , v ) )}^{2} \qquad ( 2 )$$

where E is the power of block with 8×8. pixels, f(x, y) is the luminance value of a pixel, F(u, v) is the coefficient value in the corresponding DCT domain.

In the criterion of MPEG4, for example, quantification can be realized by the following equation:

F′(u, v)=F(u, v)/2Q_{(integer division)} (3)

where F′(u, v) is the quantified discrete DCT coefficient, F(u, v) is the discrete DCT coefficient before quantification, Q is a quantification parameter.

It can be seen from equation (2) that it is obvious that F(u, v) is not larger than \sqrt{E}. If \sqrt{E}<2Q, i.e. E<4Q², then all the DCT coefficients of this block will be less than 2Q. Therefore, these coefficients will be quantified zero.

Since the standards, such as MPEG4, etc., the luminance error between the macro-block of the above current frame and that of the reference frame can be quantified and encoded only after being DCT. Therefore, at step S13, if eₖ<2Q (k=1, 2, 3, 4), that is, each error of luminance power is less than 2Q, then the difference between the current macro-block and the reference macro-block is considered small. So it is determined that it is not necessary to encode the current macro-block. This macro-block is indicated.(for instance, the indication of address information, etc. ). Then, the data of this macro-block can be obtained by decoding in accordance with the video data of the reference macro-block. Then, the flow goes to step S14. At step S14, the address information of this macro-block is added to the bit stream of the video data, as the indication of non-encoding and recovering video data based on the reference macro-block.

If the above conditions can not be met, it is determined that the current macro-block needs to be encoded. Then the flow goes to step S15, in which this macro-block will be further processed, such as motion estimation and compensation, DCT, etc.

With the above method, it can be determined whether the macro-block should be encoded without a motion prediction, a motion compensation and other processes. This greatly saves the system resources. Besides judging whether the macro-block should be encoded, the above method can also apply to other decisions on whether a data block should be coded. Further, power is not the only one which can be used as the object of comparison. In fact, whether an encoding unit should be encoded with respect to its reference unit can be decided by other parameters or conditions reflecting the degree of similarity between the two units, such as the quantity of the information, etc.

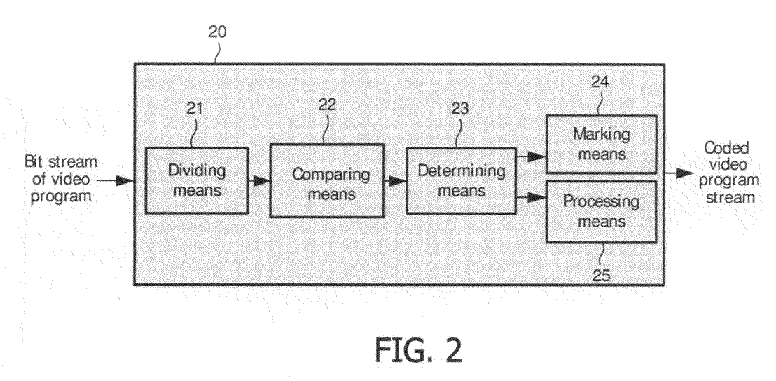

FIG. 2 is a block diagram of the apparatus for coding video data stream according to an embodiment of the invention. As shown in FIG. 2, the apparatus 20 for encoding video data stream comprises a dividing means 21 for dividing the current frame of video signal into multiple macro-blocks with 16×16 pixels, each macro-block including four luminance blocks with 8×8 pixels.

The person skilled in the art should understand that the present application should not be limited to this. The person skilled in the art should understand that the present application should not be limited to this. The invention also applies to the situation that the current frame is divided into multiple macro-blocks with 8×8 pixels or 4×4 pixels, etc., each macro-block including multiple luminance blocks with I×J pixels. Further, the macro-block in the invention may also include multiple color level blocks.

For the purpose of simplification, the following description will be based on the fact that the current frame of the video signal is divided into multiple macro-blocks with 16×16 pixels, each macro-block including four luminance blocks with 8×8 pixels.

The apparatus 20 also comprises a comparing means 22 for comparing the power error between each luminance block in the reference macro-block and that having corresponding address in the current macro-block. That is, the power error eₖ between the luminance blocks having corresponding addresses. The computing formula for eₖ is shown as equation (1).

The apparatus 20 also comprises a determining means 23 for determining whether the macro-block should be encoded on the basis of the power error determined by the comparing means 22 and a preset reference value.

if eₖ<2Q (k=1, 2, 3, 4), that is, if each power error is less than 2Q, then it is determined that it is not necessary to encode the current macro-block. Otherwise, the macro-block is determined to encode.

It should be noted that the method for determining whether the macro-block is encoded has been described in the above; the details description is omitted here.

The apparatus 20 also comprises an indicate means 24 for indicating the macro-blocks in which the power difference corresponding to each the data block is less than the preset reference value, to obtain the video data of the macro-block by decoding according to the video data of the reference data macro-block. Various methods can be used to indicate the determined non-coded macro-blocks, such as indicating according to the address information of the macro-block.

The apparatus 20 also comprises a processing means 25 for subsequently processing the macro-blocks having been determined to be encoded, such as motion estimation and compensation, DCT, quantification, rearrangement, IDCT, rebuilt and entropy coding, etc.

The method and the apparatus for encoding video data stream according to the invention can be applied to the procedure of video encoding on the basis of, for example, the criterions of MPEG2, MPEG4, etc. Therefore, they can be applied to the procedure of video encoding in a blue-ray disk with, for example, the video encoding criterions of MPEG2, MPEG4, etc.

From the above, the foregoing embodiment is described with a luminance block. It should be understood by the person skilled in the art that the color level block or both the color level block and luminance block can be used to determine whether the macro-block should be encoded. For the purpose of simplification, the detailed description of these is omitted here.

As the present invention has been described with reference to the preferred embodiments, many substitutes, modifications and variations are obvious to those skilled in the art according to the foregoing description. Therefore, the present invention will include all such substitutes, modifications and variations that fall under the concept and the scope of the appended claims.

1. A method for encoding a video data stream, wherein said video data stream comprises at least one unit to be encoded, said unit to be encoded comprises at least one data block, comprising:
comparing the difference between each data block of said unit to be encoded and a reference data block having the corresponding address in a reference unit; and
determining whether said difference corresponding to each data block complies with a predetermined condition, for determining whether said unit to be encoded should be encoded.

2. The method of claim 1, wherein the unit to be encoded comprises a data macro-block, said reference unit is a reference data macro-block.

3. The method of claim 1, wherein said difference comprises power difference.

4. The method of claim 3, wherein said power difference comprises a value of power difference, said predetermined condition comprises a predetermined reference value.

5. The method of claim 4, wherein if said value of power difference corresponding to each data block is less than said predetermined reference value, then marking said macro-block for obtaining the video data of said macro-block by decoding on the basis of video data of said reference data macro-block.

6. The method of claim 5, wherein marking said macro-block comprises: adding address information of said data macro-block to the codes of said video data stream.

7. The method of claim 4, wherein if the value of power difference corresponding to a data block of said each data block is larger than said predetermined reference value, then encoding said data macro-block.

8. The method of claim 1, wherein said data macro-block comprises four data blocks.

9. The method of claim 1, wherein said data block is a luminance block.

10. The method of claim 1, wherein said data block is a color level block.

11. The method of claim 4, wherein said predetermined reference value is a critical value of power difference of data blocks which is quantified as a specific value.

12. The method of claim 11, wherein said specific value is zero.

13. An apparatus for encoding video data stream, wherein said video data stream comprises at least one unit to be encoded, said unit to be encoded comprises at least one data block, comprising:
comparing means for comparing the difference between each data block of said unit to be encoded and a reference data block having the corresponding address in a reference unit; and
determining means for determining whether said difference corresponding to each data block complies with a predetermined condition, so as to determine whether said unit to be encoded should be encoded.

14. The apparatus of claim 13, wherein the unit to be encoded comprising a data macro-block, said reference unit being a reference data macro-block.

15. The apparatus of claim 14, wherein said power difference comprising a value of power difference, said predetermined condition comprising a predetermined reference value.

16. The apparatus of claim 15, further comprising:
marking means for marking the macro-block in which said value of power difference corresponding to each data block is less than said predetermined reference value for obtaining the video data of said macro-block by decoding on the basis of video data of said reference data macro-block.

17. The apparatus of claim 15, further comprising:
processing means for encoding the macro-block in which the value of power difference corresponding to one data block is larger than said predetermined reference value.
